(19) United States
(12) Patent Application Publication
(10) Pub. No.: US 2020/0316884 A1
(43) Pub. Date: Oct. 8, 2020

(54) SEALING COMPOSITION FOR REPAIRING TYRES

(71) Applicant: TEK GLOBAL S.R.L., Pesaro (IT)

(72) Inventor: Guido Petrelli, Pesaro (IT)

(21) Appl. No.: 16/305,232

(22) PCT Filed: Jun. 16, 2017
(86) PCT No.: PCT/EP2017/064852

§ 371 Date: Nov. 28, 2018

(30) Foreign Application Priority Data
Jun. 17, 2016 (IT) 102016000062895

(51) Int. Cl. B29C 73/16; C09K 3/10; C08L 23/08

(52) U.S. Cl. CPC B29C 73/163; C09K 3/10; C08L 2201/08; C09K 2200/0607; C08L 2205/03; C08L 23/0853

(57) ABSTRACT

Sealing composition for repairing tyres comprising: from 5% to 15% of natural latex; from 20% to 60% synthetic latex; from 30% to 60% of a glycol selected from the group consisting of propylene glycol and ethylene glycol; from 0.05% to 5% of silica; the synthetic latex comprising from 15% to 40% of ethylene-vinyl acetate, the percentages being by weight of the total composition.

### TECHNICAL FIELD

The present invention relates to a sealing composition for repairing tyres.

### BACKGROUND ART

When a tyre is punctured, it is now common practice to use a sealing composition. Said composition is poured into the tyre to repair the puncture from the inside, thus ensuring an air-tight seal of the tyre.

Different sealing compositions are known in which a rubber latex, generally natural rubber, is mixed with an adhesive and an anti-freeze agent.

The drawback, however, is that said compositions, if kept for long periods, are subject to phenomena of aggregation between the latex particles and the adhesive particles resulting in the composition taking on a creamy look. Generally, therefore, when said creamy composition is dispensed, it obstructs the dispenser valve and is not able to adequately repair the puncture.

Studies carried out by the inventors have shown that one of the causes of obstruction of the dispenser valve appears to be the large dimension of the natural rubber particles of approximately 1 micron and their non-uniform and unstable granulometric distribution.

Compositions are also known which do not contain an adhesive agent. However, also said compositions cause obstruction of the dispenser valve.

EP2655504 discloses a sealing composition comprising natural latex, synthetic latex, preferably SBR latex, an antifreezing agent, preferably propylene glycol or ethylene glycol and a mineral selected from the group consisting of phyllosilicates and silica.

This composition does not result in clogging of the dispenser valve.

However, the need is felt in the art for a new sealing composition for repairing tyres which is without the drawbacks of the known compositions, presenting increased performances in terms of shelf-life and sealing properties.

### DISCLOSURE OF INVENTION

The object of the present invention is therefore to find a sealing composition which is stable in the long term with rubber latex particles which are not subject to phenomena of aggregation resulting in obstruction of the dispenser valve, but at the same time with increased sealing capacity and shelf-life.

Said object is achieved by the sealing composition as claimed in claim 1.

In particular, according to an aspect of the invention, it is provided a sealing composition for repairing tyres comprising:
from 5% to 15% of natural latex;
from 20% to 60% synthetic latex;
from 30% to 60% of a glycol selected from the group consisting of propylene glycol and ethylene glycol;
from 0.05% to 5% of silica;

wherein said synthetic latex comprises from 15% to 40% of ethylene-vinyl acetate,

the percentages being by weight of the total composition.

More particularly, the composition comprises:
from 5% to 10% of natural latex;
from 20% to 50% synthetic latex;
from 40% to 50% of a glycol selected from the group consisting of propylene glycol and ethylene glycol;
from 0.05% to 4% of silica;

wherein the synthetic latex comprises from 20% to 30% of ethylene-vinyl acetate,

the percentages being by weight of the total composition.

It has been observed that the presence of ethylene-vinyl acetate (EVA) as part of the synthetic latex increases the sealing performances of the composition. Moreover, it has been observed an increase in the shelf life of the composition.

Advantageously the introduction of EVA allows a reduction in the content of natural latex with a reduction of ammonia odour of the sealing composition.

Preferably the synthetic latex further comprises a latex selected from the group consisting of a styrene-butadiene and carboxylated styrene-butadiene latex, more preferably, a styrene-butadiene latex.

The composition of the invention may contain silica with a BET surface area in the range between 170 and 250 m²/cm³, preferably between 175 and 225 m²/cm³.

The presence of silica performs an adjuvant action during sealing of the puncture as it penetrates into the latex mixture during polymerisation, performing a mechanical reinforcement action.

Preferably the glycol is propylene glycol.

Lastly the sealing composition can also comprise additives such as an anti-oxidant agent, preferably in an amount of 0.05-3%, more preferably 0.1-2.5%, and a stabiliser agent preferably in an amount of 0.2-3, more preferably 0.3-2%.

Further characteristics of the present invention will become clear from the following description of some merely illustrative and non-limiting examples.

### BEST MODE FOR CARRYING OUT THE INVENTION

### Example 1

Chemical-Physical Characterisation of a Sealing Composition of the Invention

The composition illustrated in Table 1 was produced according to the invention.

TABLE 1

| | Quantity |
|---|---|
| Components | (kg ± 0.5%) |
| Natural latex | 80 |
| Sodium-n-alkyl- | 15 |
| benzene sulphonate | |
| (stabilizer) | |
| Polymeric | 10 |
| hindered phenol | |
| (Antioxidant) | |
| Propylene Glycol | 390 |
| SBR | 100 |
| Silica | 4 |
| EVA latex | 211 |
| Deionized water | 190 |

The viscosity, the pH and the specific gravity (SpG) were evaluated on the composition illustrated in Table 1. The results are given in Table 2.

TABLE 2

Physical properties

| | Viscosity | Viscosity | | Specific |
|---|---|---|---|---|
| Batch | (Cps) | (Cps) | | gravity |
| number | 25° C. | −40° C. | pH | (SpG, 25° C.) |
| 1 | 34.2 | 5090 | 6.75 | 1.0439 |

### Example 2

Test for Evaluation of Sealing Properties

The sealing power of the composition was evaluated by Ford specification (ES8S43-19L523-AA) in which a puncture was made between the grooves with a 6 mm diameter steel nail.

The reduction of the tyre pressure after 30 seconds, measured to determine a linear deflation speed in kPa/min, was about 50 kPa.

Subsequently the tyre was fitted on a test car and connected to a compressor. The sealing composition of example 1 was injected into the tyre which was then inflated to 250 kPa.

The test car was driven for 10 minutes at a minimum speed of 30 km/h and maximum speed of 80 km/h, measuring the tyre pressure to evaluate the sealing power according to the pressure loss after 10 minutes and verifying any leaks from the puncture made.

Subsequently the test car was stopped and the pressure was measured again after 1 hour and 2 hours.

The results obtained are given in Table 3.

As can be seen, the sealing composition proved capable of sealing the tyre not only at ambient temperature but also at 70° C. and at −40° C.

TABLE 3

| | P drop | | | | | | | | | | | |
|---|---|---|---|---|---|---|---|---|---|---|---|---|
| | after | Injection | | | | | | | | | | |
| | 30 s | of sealing | | Tyre inflation | | | Run test | | | Run test | | |
| | P0 = | composition | | | P | | tire 3 min | | | tire 5 min | | |
| | 250 | | MaxP | MinP | final | | ΔP | Final | Suds | ΔP | Final P | Suds |
| Batch | (kPa) | t (s) | (kPa) | (kPa) | (Psi) | t | kPa | P kPa | Test | kPa | kPa | Test |

Sealing composition kept at ambient temperature

| 1 | 210 | 31″ | 469 | 98 | 38(36) | 4′41″ | 21 | 229 | OK | 0 | 229 | OK |
|---|---|---|---|---|---|---|---|---|---|---|---|---|
| 1 | 205 | 31″ | 476 | 105 | 38(36) | 4′32″ | 28 | 222 | OK | 0 | 222 | OK |
| 1 | 210 | 34″ | 504 | 112 | 38(36) | 4′22″ | 21 | 229 | OK | 0 | 229 | OK |
| 1 | 210 | 33″ | 560 | 119 | 38(36) | 3′47″ | 21 | 229 | OK | 0 | 229 | OK |
| 1 | 210 | 27″ | 546 | 119 | 39(36) | 4′24″ | 21 | 229 | OK | 0 | 229 | OK |
| 1 | 200 | 25″ | 483 | 119 | 39(36) | 4′01″ | 21 | 229 | OK | 0 | 229 | OK |
| | | | | | | Run test | | | Stop test | | Stop test | |
| | | | | | | tire 10 min | | | tire 1 | | tire 2 | |
| | | | | | | ΔP | Final | Suds | ΔP | P | ΔP | P |
| | | | | | Batch | kPa | P kPa | Test | kPa | kPa | kPa | kPa |
| | | | | | | Sealing composition kept at ambient temperature | | | | | | |
| | | | | | 1 | 21 | 229 | OK | 7 | 222 | 0 | 222 |
| | | | | | 1 | 28 | 222 | OK | 7 | 215 | 0 | 215 |
| | | | | | 1 | 21 | 229 | OK | 7 | 222 | 0 | 222 |
| | | | | | 1 | 21 | 229 | OK | 7 | 222 | 0 | 222 |
| | | | | | 1 | 14 | 236 | OK | 7 | 229 | 0 | 229 |
| | | | | | 1 | 21 | 229 | OK | 7 | 222 | 0 | 222 |
| | P drop | | | | | | | | | | | |
| | after | Injection | | | | | | | | | | |
| | 30 s | of sealing | | Tyre inflation | | | Run test | | | Run test | | |
| | P0 = | composition | | | P | | tire 3 min | | | tire 5 min | | |
| | 250 | | Max P | MinP | final | | ΔP | Fin | Suds | ΔP | Fin P | Suds |
| Batch | (kPa) | t (s) | (kPa) | (kPa) | (Psi) | t | kPa | P kPa | Test | kPa | kPa | Test |

Sealing composition kept at 70° C. for 2 hrs

| | | | | | | | | | | | | |
|---|---|---|---|---|---|---|---|---|---|---|---|---|
| 1 | 205 | 29″ | 420 | 91 | 38(36) | 4′53″ | 21 | 229 | OK | 0 | 229 | OK |
| 1 | 210 | 28″ | 434 | 91 | 38(36) | 4′18″ | 28 | 222 | OK | 0 | 222 | OK |
| 1 | 210 | 27″ | 504 | 119 | 39(36) | 4′31″ | 28 | 222 | OK | 0 | 222 | OK |
| 1 | 210 | 26″ | 490 | 98 | 38(36) | 3′53″ | 42 | 208 | OK | 0 | 208 | OK |
| 1 | 205 | 24″ | 504 | 112 | 38(36) | 4′26″ | 21 | 229 | OK | 0 | 229 | OK |
| 1 | 210 | 26″ | 504 | 112 | 38(36) | 3′47″ | 42 | 208 | OK | 7 | 201 | OK |

Sealing composition kept at −40° C. for 2 hrs

| 1 | 140 | 5′24″ | 595 | 126 | / | / | / | / | X3 | 56 | 194 | X1 |
|---|---|---|---|---|---|---|---|---|---|---|---|---|
| 1 | 190 | 5′02″ | 7006 | 126 | / | / | / | / | X3 | 14 | 236 | OK |
| 1 | 170 | 4′42″ | 6363 | 119 | / | / | / | / | X3 | 14 | 236 | X3 |
| 1 | 150 | 5′26″ | 630 | 140 | / | / | / | / | X3 | 14 | 236 | X1 |
| 1 | 160 | 3′55″ | 700 | 140 | / | / | / | / | X3 | 14 | 236 | X1 |
| 1 | 180 | 4′55″ | 630 | 140 | / | / | 14 | 236 | X2 | 0 | 236 | OK |
| | | | | | | Run test | | | Stop test | | Stop test | |
| | | | | | | tire 10 min | | | tire 1 h | | tire 2 h later | |
| | | | | | | ΔP | Final | Suds | ΔP | | ΔP | P |
| | | | | | Batch | kPa | P kPa | Test | kPa | P kPa | kPa | kPa |
| | | | | | | Sealing composition kept at 70° C. for 2 hrs | | | | | | |
| | | | | | 1 | 0 | 229 | OK | 7 | 222 | 0 | 222 |
| | | | | | 1 | 0 | 222 | OK | 7 | 215 | 0 | 215 |
| | | | | | 1 | 0 | 222 | OK | 7 | 215 | 0 | 215 |
| | | | | | 1 | 7 | 194 | OK | 7 | 187 | 0 | 187 |
| | | | | | 1 | −7 | 236 | OK | 7 | 229 | 0 | 229 |
| | | | | | 1 | 0 | 194 | OK | 7 | 187 | 0 | 187 |
| | | | | | | Sealing composition kept at −40° C. for 2 hrs | | | | | | |
| | | | | | 1 | 0 | 201 | OK | 7 | 194 | 0 | 194 |
| | | | | | 1 | 0 | 243 | OK | 7 | 236 | 0 | 236 |
| | | | | | 1 | 0 | 243 | OK | 7 | 236 | 0 | 236 |
| | | | | | 1 | −7 | 250 | OK | 7 | 243 | 0 | 243 |
| | | | | | 1 | 0 | 236 | OK | 7 | 229 | 0 | 229 |
| | | | | | 1 | 0 | 243 | OK | 7 | 236 | 0 | 236 |

| | | Injection | | | | | | |
|---|---|---|---|---|---|---|---|---|
| | Pressure drop | of | | | | | | |
| | after 30 s | sealing | | Tyre inflation | | | Run test tire | |
| | P0 = | composition | | | P | | 10 min | |
| | 250 | | MaxP | MinP | final | t min | ΔP | Final P. |
| Batch | (kPa) | t (s) | (kPa) | (kPa) | (Psi) | (s) | kPa | P kPa |

Sealing composition kept at 80° C. for 100 hours

| | | | | | | | | |
|---|---|---|---|---|---|---|---|---|
| 1 | 205 | 27″ | 420 | 98 | 38(36) | 4′41″ | 35 | 215 |
| 1 | 205 | 31″ | 406 | 105 | 38(36) | 4′16″ | 35 | 215 |
| 1 | 205 | 28″ | 385 | 98 | 38(36) | 4′37″ | 21 | 229 |

Sealing composition kept at −40° C. for 120 hours

| 1 | 160 | 6′57″ | 700 | 133 | / | / | −7 | 257 |
|---|---|---|---|---|---|---|---|---|
| 1 | 170 | 3′59″ | 700 | 126 | / | / | 14 | 236 |
| 1 | 160 | 5′37″ | 630 | 140 | / | / | 28 | 222 |
| | | | | | Stop test | | Stop test | |
| | | | | | tire 1 h later | | tire 2 h later | |
| | | | | | ΔP | | ΔP | |
| | | | | Batch | kPa | P kPa | kPa | P kPa |
| | | | | | Sealing composition kept at 80° C. for 100 hrs | | | |
| | | | | 1 | 7 | 208 | 0 | 208 |
| | | | | 1 | 7 | 208 | 0 | 208 |
| | | | | 1 | 7 | 222 | 0 | 222 |
| | | | | | Sealing composition kept at −40° C. for 120 hours | | | |
| | | | | 1 | 7 | 250 | 0 | 250 |
| | | | | 1 | 7 | 229 | 0 | 229 |
| | | | | 1 | 7 | 215 | 0 | 215 |

From low temperature of −40° C. to high temperature of 70° C., even at extreme condition of 80° C./100 hrs and −40° C./120 hrs, sealant is dispersed freely without any valve clog, and the test tires are sealed completely within 10 min. After 1 hr and 2 hrs storage, tire pressure is kept, and sealing performance is perfect.

### Example 3

Test for Evaluation of Sealing Properties after Aging

The sealing properties of the composition of example 1 (TEK9) have been evaluated after aging (45, 55, 65, 75, 85, and 105 days) and compared to those of a composition prepared according to EP2655504 (TEK8). In particular, TEK8 composition has the following composition:
29.5% Natural Latex
31% of SBR
36.6% Propylene glycol
0.6% silica

The test has been performed aging the sealing composition for the required days into an oven at 70° C. Thereafter, the test described in example 2 has been performed.

The results are illustrated in table 4.

TABLE 4

| | | | Injection of | | | | | | | | | | | | | | Stop test | Stop test |
|---|---|---|---|---|---|---|---|---|---|---|---|---|---|---|---|---|---|---|
| | | P drop | sealing | | | | | Run test | | Run test | | Run test | | Run test tire | | | tire 1 h | tire 2 h |
| | | after 30 s | composition | | Tyre inflation | | | tire 3 min | | tire 5 min | | tire 7 min | | 10 min | | | later | later |
| | Aging | P0 = 250 | | MaxP | MinP | P final | | ΔP | Suds | ΔP | Suds | ΔP | Suds | ΔP | Final | Suds | ΔP | ΔP |
| Batch | time | (kPa) | t (s) | kPa | kPa | Psi | t (s) | kPa | Test | kPa | Test | kPa | Test | kPa | P kPa | Test | kPa | kPa |
| TEK9 | 45 | 215 | 35″ | 574 | 126 | 38(36) | 4′07″ | 21 | OK | 0 | OK | 0 | OK | 0 | 229 | OK | 7 | 0 |
| TEK9 | 45 | 210 | 33″ | 532 | 126 | 40(36) | 4′06″ | 14 | OK | 0 | OK | 0 | OK | 0 | 236 | OK | 7 | 0 |
| TEK9 | 55 | 215 | 28″ | 546 | 112 | 38(36) | 3′41″ | 21 | OK | 0 | OK | 0 | OK | 0 | 229 | OK | 7 | 0 |
| TEK9 | 55 | 210 | 35″ | 560 | 126 | 38(36) | 3′37″ | 21 | OK | 0 | OK | 0 | OK | 0 | 229 | OK | 7 | 0 |
| TEK9 | 65 | 205 | 32″ | 469 | 105 | 39(36) | 3′55″ | 28 | OK | 0 | OK | 0 | OK | 0 | 222 | OK | 0 | 7 |
| TEK9 | 65 | 205 | 32″ | 476 | 119 | 38(36) | 4′29″ | 21 | OK | −7 | OK | 0 | OK | 0 | 236 | OK | 7 | 0 |
| TEK9 | 75 | 205 | 31″ | 532 | 112 | 38(36) | 4′09″ | 14 | OK | 0 | OK | 0 | OK | 0 | 236 | OK | 7 | 0 |
| TEK9 | 75 | 195 | 33″ | 511 | 112 | 39(36) | 4′24″ | 14 | OK | 0 | OK | 0 | OK | 0 | 236 | OK | 7 | 0 |
| TEK9 | 75 | 205 | 32″ | 455 | 105 | 38(36) | 4′21″ | 28 | OK | 0 | OK | 0 | OK | 0 | 222 | OK | 7 | 0 |
| TEK9 | 75 | 205 | 30″ | 504 | 119 | 39(36) | 3′57″ | 14 | OK | −7 | OK | 0 | OK | 0 | 236 | OK | 7 | 0 |
| TEK9 | 75 | 210 | 33″ | 574 | 119 | 39(36) | 4′09″ | 21 | OK | 0 | OK | 0 | OK | 0 | 229 | OK | 7 | 0 |
| | | | Injection of | | | | | | | | | | | | | | Stop test | Stop test |
| | | P drop | sealing | | | | | Run test | | Run test | | Run test | | Run test tire | | | tire 1 h | tire 2 h |
| | | after 30 s | composition | | Tyre inflation | | | tire 3 min | | tire 5 min | | tire 7 min | | 10 min | | | later | later |
| | Aging | P0 = 250 | | MaxP | MinP | Pfinal | | ΔP | Suds | ΔP | Suds | ΔP | Suds | ΔP | Final | Suds | ΔP | ΔP |
| Batch | time | (kPa) | t (s) | kPa | kPa | Psi | t | kPa | Test | kPa | Test | kPa | Test | kPa | P kPa | Test | kPa | kPa |
| TEK9 | 85 | 210 | 27″ | 546 | 126 | 39(36) | 3′53″ | 21 | OK | 0 | OK | 0 | OK | 0 | 229 | OK | 7 | 0 |
| TEK9 | 85 | 205 | 30″ | 567 | 126 | 38(36) | 3′39″ | 21 | OK | 0 | OK | 0 | OK | −7 | 236 | OK | 7 | 0 |
| TEK9 | 85 | 200 | 26″ | 560 | 105 | 39(36) | 5′11″ | 21 | OK | 0 | OK | 0 | OK | −7 | 236 | OK | 7 | 0 |
| TEK9 | 85 | 210 | 29″ | 532 | 126 | 39(36) | 3′34″ | 21 | OK | 0 | OK | 0 | OK | 0 | 229 | OK | 7 | 0 |
| TEK9 | 85 | 205 | 29″ | 490 | 112 | 38(36) | 4′01″ | 0 | OK | 0 | OK | −7 | OK | 0 | 236 | OK | 7 | 0 |
| TEK9 | 95 | 205 | 33″ | 511 | 126 | 38(36) | 3′41″ | 21 | OK | −7 | OK | 0 | OK | 0 | 236 | OK | 7 | 0 |
| TEK9 | 95 | 205 | 31″ | 539 | 119 | 38(36) | 4′06″ | 21 | OK | −7 | OK | 0 | OK | 0 | 236 | OK | 7 | 0 |
| TEK9 | 95 | 205 | 30″ | 574 | 119 | 38(36) | 3′50″ | 0 | OK | 0 | OK | 0 | OK | 0 | 229 | OK | 7 | 0 |
| TEK9 | 95 | 205 | 28″ | 518 | 112 | 39(36) | 3′45″ | 14 | OK | 0 | OK | 0 | OK | 0 | 236 | OK | 7 | 0 |
| TEK9 | 95 | 200 | 29″ | 518 | 105 | 38(36) | 4′24″ | 14 | OK | 0 | OK | 0 | OK | 0 | 236 | OK | 7 | 0 |
| TEK9 | 105 | 205 | 31″ | 518 | 112 | 38(36) | 3′41″ | 14 | OK | −7 | OK | 0 | OK | 0 | 236 | OK | 7 | 0 |
| TEK9 | 105 | 200 | 30″ | 532 | 105 | 38(36) | 4′07″ | 28 | OK | −7 | OK | 0 | OK | −7 | 236 | OK | 7 | 0 |
| TEK9 | 105 | 205 | 31″ | 546 | 119 | 38(36) | 4′19″ | 21 | OK | 0 | OK | 0 | OK | 0 | 229 | OK | 7 | 0 |
| TEK9 | 105 | 210 | 30″ | 511 | 105 | 38(36) | 4′08″ | 14 | OK | 0 | OK | 0 | OK | 0 | 236 | OK | 7 | 0 |
| TEK9 | 105 | 205 | 30″ | 504 | 112 | 39(36) | 3′57″ | 21 | X1 | −7 | OK | 0 | OK | 0 | 236 | OK | 7 | 0 |
| TEK8 | 45 | 200 | 31″ | 496 | 110 | 37(35) | 5′26″ | 14 | OK | 0 | OK | 0 | OK | 0 | 227 | OK | 7 | 7 |
| TEK8 | 45 | 200 | 32″ | 523 | 96 | 37(35) | 6′24″ | 28 | OK | 0 | OK | 0 | OK | 0 | 213 | OK | 7 | 0 |
| TEK8 | 45 | 200 | 30″ | 592 | 96 | 37(35) | 5′36″ | 28 | X | 21 | x | 0 | OK | 0 | 192 | OK | 14 | 0 |
| TEK8 | 55 | 200 | 25″ | 440 | 82 | 37(35) | 6′24″ | 34 | X | 14 | OK | 0 | OK | 0 | 213 | OK | 7 | 7 |
| TEK8 | 55 | 200 | 32″ | 454 | 110 | 37(35) | 6′30″ | 14 | OK | 0 | OK | 0 | OK | 0 | 234 | OK | 14 | 7 |
| TEK8 | 55 | 200 | 24″ | 510 | 110 | 37(35) | 6′44″ | 14 | X | 7 | OK | 0 | OK | 0 | 220 | OK | 7 | 7 |
| TEK8 | 65 | 200 | 29″ | 510 | 82 | 37(35) | 6′19″ | 7 | OK | 0 | OK | −7 | OK | 0 | 241 | OK | 7 | 7 |
| TEK8 | 65 | 200 | 22″ | 585 | 96 | 255(241) | 6′16″ | 7 | OK | 0 | OK | 0 | OK | 0 | 241 | OK | 7 | 7 |
| TEK8 | 75 | 200 | 29″ | 510 | 96 | 261(241) | 5′56″ | 21 | OK | 0 | OK | −7 | OK | 0 | 234 | OK | 7 | 7 |
| TEK8 | 75 | 200 | 26″ | 496 | 96 | 255(241) | 6′04″ | 7 | OK | 0 | OK | 0 | OK | 0 | 234 | OK | 7 | 7 |
| TEK8 | 75 | 200 | 24″ | 523 | 96 | 255(241) | 6′24″ | 14 | X | 7 | OK | 7 | OK | 0 | 213 | OK | 7 | 7 |

As evident from the data in Table 4, TEK9 performs better after aging than the sealing composition of the prior art (TEK8). In particular, the composition of the invention is more stable after aging, sealing the tyre at least 2 minutes before the composition of the prior art.

Moreover, the experimental data demonstrates that the aging affects also the viscosity of the composition of the prior art (see table 5).

TABLE 5

Physical properties

| | | Viscosity | Status after blended |
|---|---|---|---|
| Aging days | Batch | (Cps) 20-100 | for 1 min |
| 0 | TEK8 | 61.7 | No coagulation |
| 15 | TEK8 | 72.8 | No coagulation |
| 25 | TEK8 | 42.4 | No coagulation |
| 35 | TEK8 | 58.7 | No coagulation |
| 45 | TEK8 | 42.2 | No coagulation |
| 55 | TEK8 | 45.8 | No coagulation |
| 65 | TEK8 | 47.5 | No coagulation |
| 75 | TEK8 | 36.1 | No coagulation |
| 0 | TEK9 | 34.2 | No coagulation |
| 15 | TEK9 | 35.7 | No coagulation |
| 25 | TEK9 | 57.2 | No coagulation |
| 35 | TEK9 | 77.6 | No coagulation |
| 45 | TEK9 | 92.6 | No coagulation |
| 55 | TEK9 | 97 | No coagulation |
| 65 | TEK9 | 77.1 | No coagulation |
| 75 | TEK9 | 89.5 | No coagulation |
| 85 | TEK9 | 84.8 | No coagulation |
| 95 | TEK9 | 78.1 | No coagulation |
| 105 | TEK9 | 74.8 | No coagulation |

Viscosity of aged sealant increases initially, and then the viscosity decreases. In the ageing process of TEK8, viscosity at 75 days (36.1 cps) decreased about 41% than the initial (36.1 cps). On the contrary, for the TEK9 aged sealant, viscosity still keeps sticky with 74.8 Cps after 105 days ageing.

1. A sealing composition for repairing tyres comprising:
from 5% to 15% of natural latex;
from 20% to 60% synthetic latex;
from 30% to 60% of a glycol selected from the group consisting of propylene glycol and ethylene glycol;
from 0.05% to 5% of silica;
characterized in that said synthetic latex comprises from 15% to 40% of ethylene-vinyl acetate,
the percentages being by weight of the total composition.

2. The composition according to claim 1, characterized in that it comprises:
from 5% to 10% of natural latex;
from 20% to 50% synthetic latex;
from 40% to 50% of a glycol selected from the group consisting of propylene glycol and ethylene glycol;
from 0.05% to 4% of silica;
characterized in that said synthetic latex comprises from 20% to 30% of ethylene-vinyl acetate,
the percentages being by weight of the total composition.

3. The composition according to claim 1, characterized in that said silica has a BET surface area in the range between 170 and 250 m²/cm³.

4. The sealing composition according to claim 1, characterised in that said synthetic latex further comprises a latex selected from the group consisting of a styrene-butadiene and carboxylated styrene-butadiene latex.

5. The sealing composition according to claim 4, characterised in that said synthetic latex is a styrene-butadiene latex.

6. The sealing composition according to claim 1, characterised in that said glycol is propylene glycol.

7. The sealing composition according to claim 1, characterised in that it further comprises an anti-oxidant agent and a stabilising agent.

8. The sealing composition according to claim 7, characterised by comprising 0.05-3% of said antioxidant agent and 0.2-3% of said stabilising agent.
